(19) United States
(12) Patent Application Publication
(10) Pub. No.: US 2010/0070442 A1
(43) Pub. Date: Mar. 18, 2010

(54) ORGANIZING KNOWLEDGE DATA AND EXPERIENCE DATA

(75) Inventor: RUDIGER KREUTER, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, Munchen (DE)

(21) Appl. No.: 12/210,295

(22) Filed: Sep. 15, 2008

(51) Int. Cl. G06N 5/02; G06F 17/30; G06F 7/00

(52) U.S. Cl. 706/14; 706/60; 707/E17.055

(57) ABSTRACT

Improvement projects in large organizations are often driven by process engineers with different backgrounds and different experiences. In such an environment is useful to support the process engineers by an effective knowledge management. Typically process knowledge of an organization is represented by a reference process having tables containing process objects with descriptions for e.g. roles, tasks and work products. By assigning annotations containing experiences gained from performed counseling projects to the respective objects of the tables, experiences made by consultants performing these projects can be added to the reference process in a formal way. This improves the reusability of knowledge and experience inherent in an organization.

### FIELD OF THE INVENTION

The invention generally relates to a method and a system for organizing knowledge data and experience data originated from counseling projects.

### BACKGROUND OF THE INVENTION

Process consultants, which support systems engineers in the definition of their development processes (e.g. software or product development processes), typically use systems engineering methods like requirements engineering, reuse or knowledge management.

Improving development processes in large organizations automatically inherits the need for standardization and customization at the same time. On one hand, standardization of process language and a common process base is desired to reduce process definition, maintenance, and training costs across the whole organization. On the other hand a customization towards the needs of the target environment is necessary for optimizing productivity. This is complex in an environment with many historically grown and therefore typically different process landscapes. It is even more complex because improvements in large organizations are often driven by many process engineers with different backgrounds and different experiences. In such an environment it is useful to support the process engineers by an effective knowledge management.

U.S. Pat. No. 5,493,729 discloses a processing system and an expert system for processing knowledge data of a knowledge data base, but focused on electrical power plants.

U.S. Pat. No. 5,715,468 discloses a memory system for storing and retrieving experience data and knowledge data with natural language.

The patent application US2003/0225748 discloses a method for managing project knowledge.

What is needed is a method and a system for organizing and storing knowledge data and experience data for an easy reusability in subsequent projects, especially consulting projects.

### SUMMARY OF THE INVENTION

One aspect of the invention is a method for organizing knowledge data and experience data originated from counseling projects, the method comprising:

providing a reference process representing the knowledge of an organization regarding processes to be used for counseling by the organization,

wherein the reference process is represented by tables containing process objects and/or content objects with a detailed description for each object and tables containing links between the process objects and/or content objects; and

assigning annotations containing experiences gained from performed counseling projects to the respective objects of the tables.

A further aspect of the invention is a system for structured storing knowledge data and experience data obtained from projects, the system comprising:

means for providing a reference process representing the knowledge of an organization, wherein the reference process is represented by tables containing process objects and/or content objects having a detailed description for each object and tables containing links between the process objects and/or content objects and

means for assigning annotations containing experiences gained from performed projects to the respective process objects of the tables.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 shows an example of an architecture of a reference process,

FIG. 2 shows an exemplary task description table,

FIG. 3 shows an exemplary table with objects and assigned annotations,

FIG. 4 shows a first exemplary flowchart for maintaining the reference process,

FIG. 5 shows a second exemplary flowchart for maintaining the reference process,

FIG. 6 shows an exemplary flowchart for performing the inventive method, and

FIG. 7 shows an exemplary implementation approach for the present invention.

### DESCRIPTION OF THE PREFERRED EMBODIMENTS

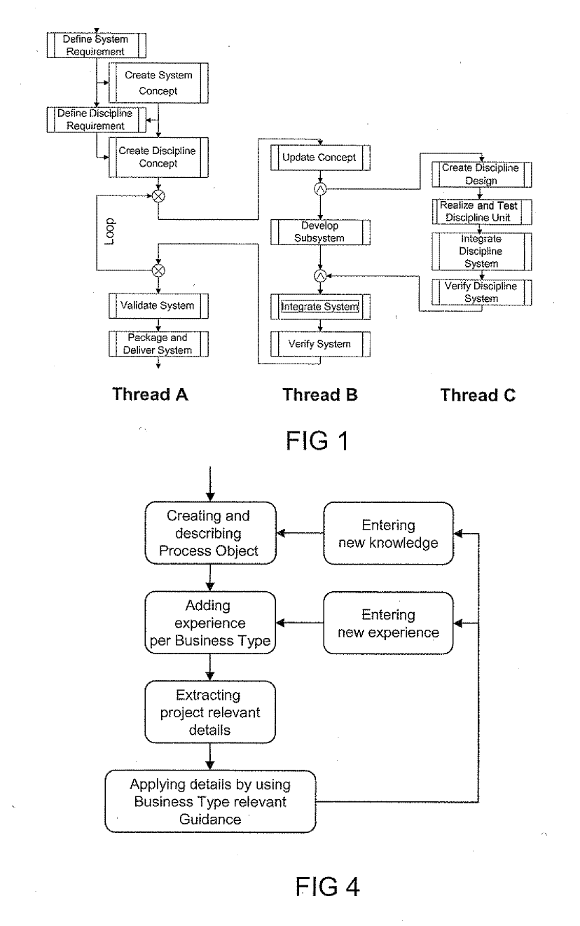

FIG. 1 shows an example of an architecture of a reference process. In FIG. 1 the reference process is described by a block diagram.

The intention of a reference process is to document the essence of state of the art information, enriched with experience derived from performed projects, e.g. improvement projects, for supporting a common understanding of processes in an organization and direct use in daily work of members of the organization.

As a segment of knowledge management, the reference process is not intended to be used as is. It is more like a generalized process pattern which needs to be tailored and adapted to respective particular environments.

A reference process for consulting organizations has to support consultants in all relevant business fields and domains. A reference process for engineers has to support engineers in the relevant fields of technology. Typically reference processes have a structure, e.g. according subsystems, line of products, development or consulting disciplines. It is not possible to define one fine grain reference process that efficiently supports the whole variation as described above. Therefore the reference process needs to be generic to a certain degree. At the same time the content needs to show enough details to really be helpful. For a systems engineering reference process it is essential to show the interfaces (prerequisites, deliveries, commitments, synchronization) between system and subsystem, between system/subsystem and development disciplines, and between the disciplines. The content of the reference process is generalized; i.e. there is normally no product, business field or organization specific content. For the use in improvement projects the consultant needs to perform customization, that is translation and adaptation towards the target organization's process language and business needs. The same holds for engineering projects.

Task chains include forking and combining, using logical operators (and, or, xor), as shown in FIG. 1. In “Thread B” of FIG. 1 there are two and-operators used. They may include Events at certain locations, to indicate a dedicated process state. Events define a certain state, they are mainly used if a Milestone is reached, or to indicate which of several parallel patties shall be followed. FIG. 1 shows that there are several separate development path' within the iteration loop of “Thread A”, based on a common updated concept and delivering to system integration.

Even though the number of process objects is small, the content and intention of each process object itself is described in detail. In fact, a process object description shall be a superset, because it is faster to erase from predefined content than to think up add-ons. Some objects are marked as optional, if they are clearly related to special business environments, like safety related objects. For the use in improvement projects the granularity needs an adaptation towards the size of the target organization and its typical projects. For instance large projects may need a more detailed and fitted management process objects, whereas small projects could do without subproject management. Large organizations will need a more extensive multi project management than small organizations.

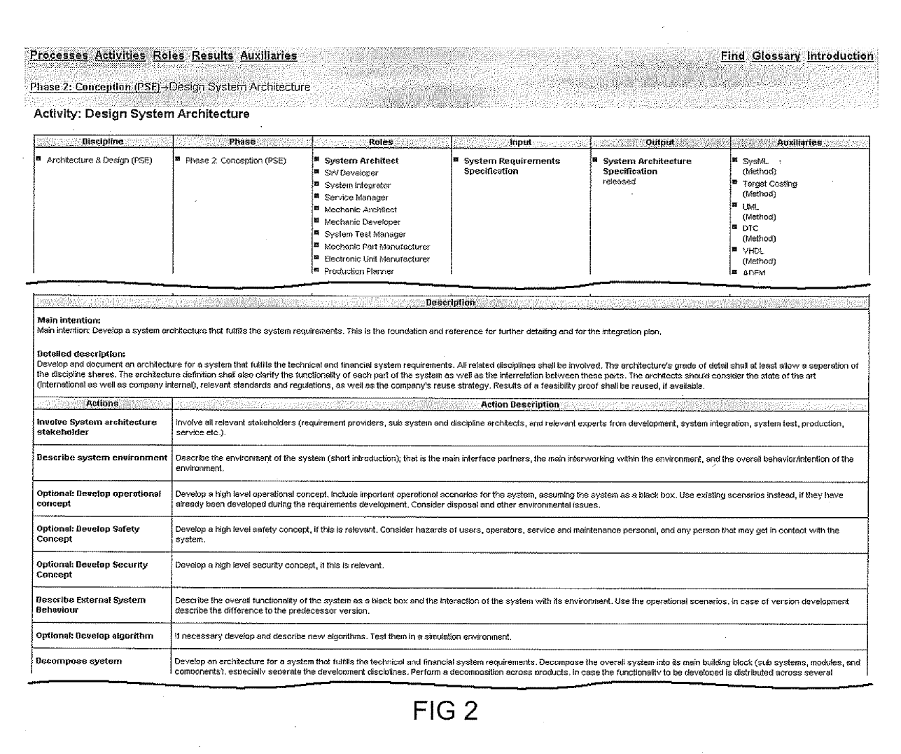

FIG. 2 shows an exemplary task description table. Description tables can be regarded as a means for process visualization. It is easy to process, to spread and to store tables electronically, for instance by using commercial spread sheet programs. The task description table of FIG. 2 shows the task “Design System Architecture” and linked objects; it comprises:
Description
List of roles, inputs, outputs, auxiliaries
List of actions.
   Description tables can also be used to represent processes, roles, results or auxiliaries. Description tables can be easily amended or modified.

As a knowledge management segment, the core use of the reference process (presented in EPC, FAD, tables or other notation) is support for daily work. Therefore it provides a database with patterns for the definition of a process architecture and process objects. There are several types of usage a reference process:

1. The reference process provides a method and tool to document the essence of knowledge gained during the daily work in a structured and compact way. Advantageously the reference process is implemented using a tool, e.g. ARIS®. Tool support allows easily to define and maintain the process objects and the allocation of Roles, Work Products, and Auxiliaries to Tasks. Furthermore a tool supports process consistency and the adherence to implementation guidelines during defining the process.

2. The information stored in the reference process is used as a generalized best practice example. It can be used as pattern for target process definition or as checklist for process reviews or a gap analysis. The usage scope ranges from defining a complete new process from scratch down to the update of single process objects, like a role description. In most cases only subsets of the information are needed. Therefore the process definition tool chain supports the generation of filtered process subsets.

3. The reference process is only one segment for knowledge management. Another segment is an experience database with examples, training slides and other archived information, stored in a configuration management system. Links from reference process objects into the experience database allow for fast search of topic related information. In this way the reference process provides structured portal into add on information.

4. There are additional possibilities to use the reference process, besides its use in process improvement projects:
Building a common understanding of process details within our group.
Example within process training
Process definition process example within process training
Use of the tool chain and process definition process in improvement projects
Playground for new ideas

A reference process is an effective method to store and recall the essence of process consulting experience. Like reuse assets for a product development it accelerates the process definition process and enhances quality by using pre tested deliveries. The mixture of generalized coarse grain process objects, with detailed object descriptions in high quality, supports a large variety span regarding business fields and domains, technical scope and organization. Especially it supports a best practice exchange across the different business fields. The intensive use of the provided process patterns in all improvement projects drives process harmonization at a fine granular level across the organization, which is a wanted side effect.

A knowledge data base stores and provides the knowledge of an organization. Maintaining and administrating experience data is normally done outside the knowledge data base. For this the content and the semantic data structure of the knowledge data base has to be emulated, because the experiences have to be incorporated in the knowledge data base, this approach is onerous and inefficient. In many cases experiences are collected independently from existing knowledge data bases and have to be assigned retroactively to objects of the knowledge data base. By this more or less unsystematic approach important findings could be easily ignored. Today there exist several approaches to collect knowledge and experiences stemming from projects (e.g. consulting projects or development projects): File systems, data bases, data warehouse, feedback sheets, Intranets, Wikis or other hypertext based systems. The disadvantage of these approaches is that it is not ensured that all knowledge, all experiences and all relationships between knowledge and respective experiences is systematically skimmed and incorporated for further reuse. Furthermore hypertext based approaches are very flexible regarding enhancements and amendments, but they are cumbersome for automatically interpreting and evaluating big amounts of data. Data bases provide a structured and consistent storing of data according a defined scheme. Therefore data can be easily and automatically interpreted and evaluated. However data bases are quite inflexible regarding enhancements and amendments.

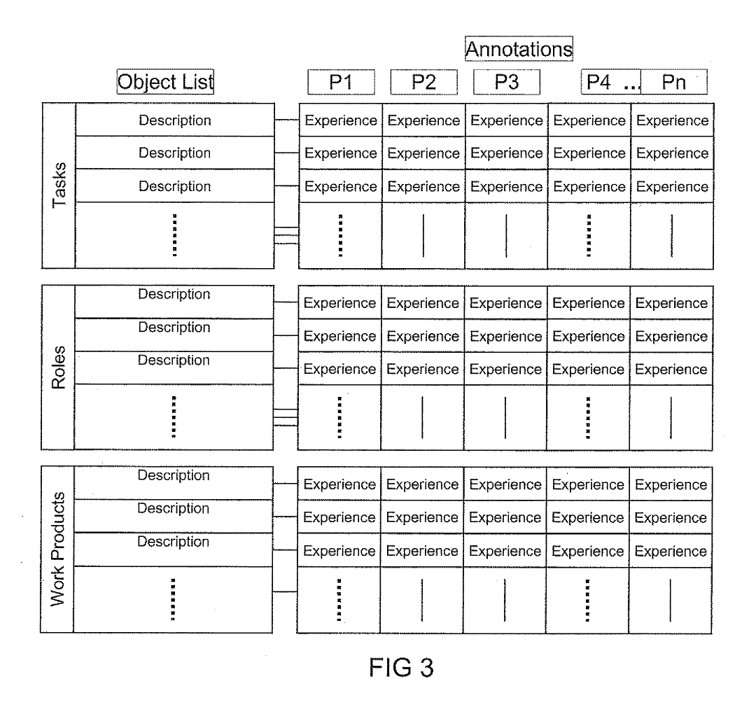

FIG. 3 shows an exemplary table with objects for describing and representing knowledge and assigned annotations representing experiences gained from projects P1 to Pn. The table shown in FIG. 3 represents an exemplary structure of a knowledge data base. The objects (e.g. process objects) are structured in Tasks, Roles and Work Products. Each object of the object list comprises a dedicated description. To the objects are assigned Annotations comprising experiences stemming from performed projects P1 to Pn. It is traceable which experience are stemming from a respective project. Not necessarily to every object in every project an experience has to be assigned. The direct correlation of the experiences to the objects in the knowledge data base allows an easy analysis of the experiences across several projects. For this analysis statistical and mathematical methods can be used. The Object List with the process objects can be used as a checklist for systematically and comprehensively collecting experiences during or after a project. The Annotations in the table of FIG. 3 are context sensitive data fields which can furthermore comprise an interpretation guideline how to interpret a process object (content element or process element) in a respective context. The table can represent several orthogonal context groups. This allows that the reference process and the table process objects can be used immediately in different contexts without further adaption. Advantageously for every context a dedicated interpretation guideline is available and stored.

For example, the contexts reflect situations and circumstances of respective customers. A user of the reference process (e.g. a consultant) can now find information in the respective interpretation guideline how to use the reference process in the context of a respective customer. For example, a context group can support the consultant when adapting a business model (e.g. product development) and another context group can support the consultant when introducing a working model (e.g. collaboration of distributed development groups). The reference process provides an interaction of orthogonal contexts and furthermore a hierarchical structuring of context groups. By using context sensitive interpretation guidelines the search for dedicated process objects for the use and reuse in dedicated environments (e.g. customers) is easy to accomplish.

By this means the knowledge data base (process objects with descriptions) is combined with an experience data base providing guideline how to use and apply the respective knowledge. To apply knowledge and experience from the data base in a specific project, relevant parts of the data base have to be extracted and provided to the respective persons (e.g. project manager, project members).

Process objects and/or content objects can be roles (set of related professional skills, capabilities, competencies, responsibilities of a person), tasks (unit of work), work products (something applied, created, or modified by a task), tools, methods (explain how to do a task in detail), or templates. Content guidance is supplemental information assigned to a content element.

By coupling and linking (assigning and storing annotations to process objects and/or content objects) the knowledge data base with the experience data base a structured data management and an efficient and systematic administration of the data base is ensured. Furthermore the combined long-term storing of knowledge and experience permits the application of statistical methods over several projects. For example, the frequency or occurrence of a stored and assigned experience in the data base can be evaluated. Based on this information the description of a process object and/or content object can be adapted. Thus information from the experience section (annotations) is moving to the knowledge section (tasks, roles, work products, etc). By using defined keywords for the annotations the input to the experiences can be normalized and by this way the statistical evaluations can be performed automatically. The statistical evaluations can be performed by using a commercially available computer system with standard software (e.g. spread sheet programs). Formal debriefings after a finished project make sure the use of defined keywords.

FIG. 4 shows an exemplary flowchart for maintaining the reference process. New findings (knowledge and experience) from running or finished projects flow back to the data base representing the reference process in a structured and managed way. The boxes in FIG. 4 represent activities to maintain and to use the reference process. In the activity “Creating and describing Process Object” a new process object (content element or process element) for the reference process is created in the data base if necessary. Access to the data base can be limited to authorized staff. In the activity “Adding experience per Business Type” experience (e.g. from new projects) will be assigned to the respective process objects. In the step “Extracting project relevant details” details from the reference process will be derived or extracted for reuse in a new project (e.g. for planning and preparing the project). In the activity “Applying details by using Business Type relevant Guidance” the extracted project relevant details will be applied to the new project. After performing or finishing the new project, in the activities “Entering new knowledge” and “Entering new experience” the newly gained knowledge or experience will be added to the reference process. The new knowledge and experience can be gained by formal or informal debriefings after finishing a project. E.g. by using questionnaires and defined keywords.

FIG. 5 shows a second exemplary flowchart for maintaining the reference process. Also in FIG. 5 the boxes represent activities to maintain and to use the reference process. In the activity “Creating and describing Process Object” a new process object and/or content object for the reference process is created in the data base if necessary. Also in the process described in FIG. 5 access to the data base for amending the reference process can be limited to authorized staff. In FIG. 5 the left hand branch shows manual activities to administer and use the reference process. But performing manual debriefings and manual evaluations is onerous, tedious, error prone, inefficient and can not be automatically performed. On the other hand FIG. 5 shows with the right hand branch a way to use the reference process more efficiently. Formal debriefings by using well defined keywords an automatic and computerized evaluation of the experiences stored and assigned to the reference process over several projects. In the activity “Adjusting Process Objects based on the Results of Evaluation of the Experiences” new knowledge and/or new experience will be added to the reference process.

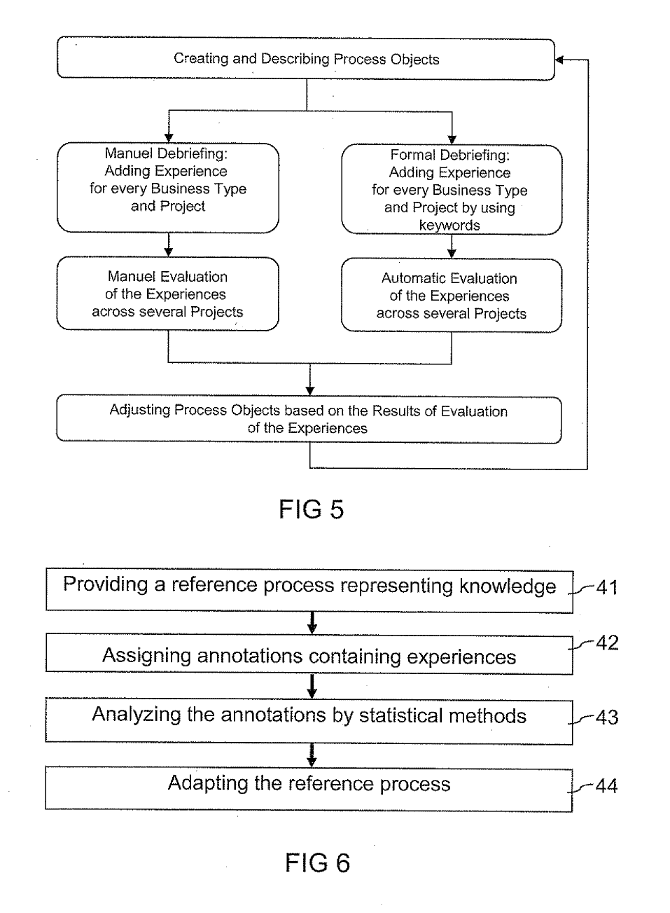

FIG. 6 shows an exemplary flowchart for performing the inventive method. The steps 41 “Providing a reference process representing knowledge” and 42 “Assigning annotations containing experiences” are mandatory. In step 41 the general knowledge about a process (e.g. development process, production process, compliance process) will be provided and stored by using a reference process. The reference process can be represented graphically, by a table or a set of tables, or textual.

For example, the reference process is described by using the semi-formal modeling language Event-Driven-Process-Chains (EPC) which can be extended by associated Function-Allocation-Diagrams (FAD). Event-Driven-Process-Chains and Function-Allocation-Diagrams can be provided manually by Software or Systems Engineers or Architects or they can be provided as exports (e.g. in the XML format (Extended Markup Language)) from process modeling tools. The intention of a reference process is to document the essence of state of the art information, enriched with experience derived from performed projects, e.g. improvement projects, for supporting a common understanding of processes in an organization and direct use in daily work of members of the organization. Advantageously for computerized processing the reference process can be represented in a data base by tables. Tables can be easily maintained, modified, or amended. EPC Diagrams can be automatically converted or transformed to tables.

In step 42 “Assigning annotations containing experiences” to the process objects of the reference process annotations comprising experiences stemming from performed projects are assigned. By this way the knowledge data base (process objects with descriptions) is combined with an experience data base providing guideline how to use and apply the respective knowledge. To apply knowledge and experience from the data base in a specific project, relevant parts of the data base have to be extracted and provided to the respective persons (e.g. project manager, project members).

In step 43 “Analyzing the annotations by statistical methods” the experiences collected across several projects are analyzed and evaluated. By using defined keywords for the annotations the input to the experiences can be normalized and by this way the statistical evaluations can be performed automatically. Formal debriefings after a finished project make sure the use of defined keywords.

The statistical evaluations can be performed by using a commercially available computer system with standard software (e.g. spread sheet programs or statistic programs). The statistical evaluations can also be performed by using Statistical Process Control mechanisms (SPC). Statistical Process Control (SPC) is a powerful tool to analyze the stability of processes by using control charts to compare the measurable attributes of the process output against the natural limits of process variation. If the observed variability of the attributes is within the range of variability from natural causes, the process is said to be under statistical control. Depending on the nature of the process and the type of attributes to be analyzed, there exist different control chart types which correspond to different natural causes of variation. For data which corresponds to continuous physical parameters, the variation across the objects in a sample can be analyzed using control charts for variables data (e.g. XmR-Charts), where the natural process limits are derived from the empirical variation in the data. Process stability here means that the observed distribution of the data does not show any pattern and does not include extreme outliers, and the random variation can be explained by natural causes. On the other hand, counting data whose variation is due to Binomial or Poisson statistics can be analyzed using control charts for attributes data (e.g. c-Charts, u-Charts), where the natural process limits are defined by the underlying statistics. Process stability here means that the observed distribution of the data can be explained by the known properties of the underlying statistics.

In step 44 “Adapting the reference process” new knowledge and/or experience derived from new projects flows back to the reference process. Access control mechanisms avoid an uncontrolled growth of the data base representing the reference process.

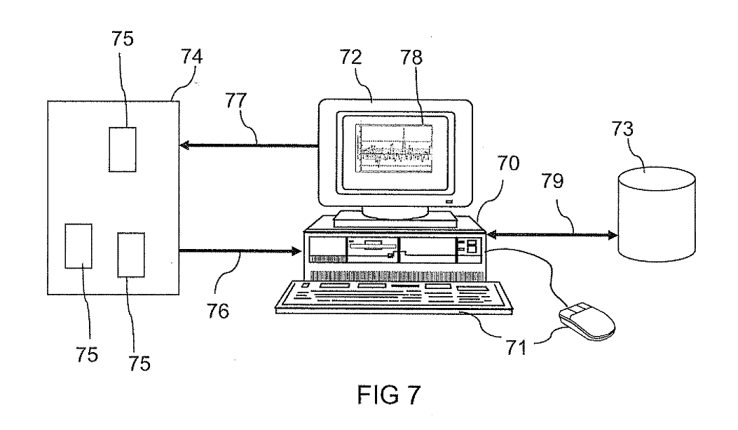

FIG. 7 shows an exemplary implementation approach for the present invention. In FIG. 7 the box 74 shows an abstract representation of the reference process with abstract process objects 75. Physically the reference process is stored in a data base 73 and can be accessed via the computer system 70. The computer system 70 further comprises input means 71 (e.g. mouse, keyboard, touch pen) and a monitor 72 to display the reference process and the process elements. By using the input means 71 it is possible to make amendments and modifications to the process elements 75. By this way new knowledge and new experience can be added to the reference process 74 and be stored in the data base 73. The arrows 76 and 77 show a loop in the system presented in FIG. 7. The arrows 76 shows that knowledge and experience represented in the reference process can be extracted, analyzed and reused in further projects. The arrow 77 shows that after performing a new project, knowledge and experience gained from the new project can be entered into the reference process. The diagram 78 shows a SPC control chart which can be used for statistically analyzing the reference process 74.

We claim:

1. A method for organizing knowledge data and experience data originated from counseling projects, the method comprising:
providing a reference process representing the knowledge of an organization regarding processes to be used for counseling by the organization,
wherein the reference process is represented by tables containing process objects and/or content objects with a detailed description for each object and tables containing links between the process objects and/or content objects; and
assigning annotations containing experiences gained from performed counseling projects to the respective objects of the tables.

2. The method according to claim 1, wherein the process objects and/or content objects containing context sensitive data fields having information how to interpret the object in a respective context.

3. The method according to claim 1, wherein a process object and/or a content object is a task, a role, a tool, a method, a template, or a work product.

4. The method according to claim 2, wherein a process object and/or a content object is a task, a role, a tool, a method, a template, or a work product.

5. The method according to claim 1, wherein the experiences are obtained and formulated by a debriefing at the end of a counseling project, wherein within the debriefing predefined keywords are assigned to the experiences.

6. The method according to claim 1, further comprising:
analyzing the annotations by statistical methods.

7. The method according to claim 6, further comprising:
adapting the objects of the reference process based on results gained by analyzing the annotations.

8. The method according to claim 1, wherein the reference process is provided as an Event Driven Process Chain (EPC) model or a task chain model or a work product chain model.

9. The method according to claim 1, wherein the reference process is stored in a data base for reuse by members of an organization.

10. The method according to claim 1, wherein said method is performed under control of a computer program.

11. The method according to claim 10, wherein the computer program is read from a data carrier.

12. A system for structured storing knowledge data and experience data obtained from projects, the system comprising:
means for providing a reference process representing the knowledge of an organization, wherein the reference process is represented by tables containing process objects and/or content objects having a detailed description for each object and tables containing links between the process objects and/or content objects and
means for assigning annotations containing experiences gained from performed projects to the respective process objects of the tables.

13. The system according to claim 12, wherein the projects are counseling projects.

14. The system according to claim 12, further comprising:
means for analyzing the annotations by statistical methods.

15. The system according to claim 14, further comprising:
means for adapting the objects of the reference process based on results gained by analyzing the annotations.

16. The system according to claim 12, wherein the process objects and/or content objects containing context sensitive data fields having information how to interpret an object of the reference process in a respective context.

17. The system according to claim 12, wherein a process object and/or a content object is a task, a role, a tool, a method, a template, or a work product.

18. The system according to claim 12, further comprising:
means for processing and/or storing the reference process.
